(19) United States
(12) Patent Application Publication
(10) Pub. No.: US 2016/0324121 A1
(43) Pub. Date: Nov. 10, 2016

(54) House Training Device for a Pet

(71) Applicant: Justin Rains, Port Orchard, WA (US)

(72) Inventor: Justin Rains, Port Orchard, WA (US)

(21) Appl. No.: 15/146,608

(22) Filed: May 4, 2016

Related U.S. Application Data
(60) Provisional application No. 62/156,494, filed on May 4, 2015.

(51) Int. Cl. A01K 15/02; A01K 1/01; A01K 29/00; A01K 5/02

(52) U.S. Cl. CPC A01K 15/021; A01K 5/02; A01K 1/0107; A01K 29/005

(57) ABSTRACT

A house training device for use in teaching a pet to urinate or defecate in a designated location. The house training device includes a pad on which the pet can urinate and defecate and a treat dispenser operably connected to the pad via a control circuit. A disposable sheet can be positioned on the upper surface of the pad in order to absorb urine and hold any fecal matter, and the pad includes a sensor therein that detects if the pet has relieved itself on the pad. The control circuit is configured to cause the treat dispenser to automatically dispense an edible treat for the pet if the sensor determines that the pet has relieved itself on the pad.

### CROSS REFERENCE TO RELATED APPLICATION

This application claims the benefit of U.S. Provisional Application No. 62/156,494 filed on May 4, 2015. The above identified patent application is herein incorporated by reference in its entirety to provide continuity of disclosure.

### BACKGROUND OF THE INVENTION

### Field of the Invention

The present invention relates to house training devices. More specifically, the present invention provides a house training device for a pet comprising a pad on which a pet may urinate or defecate and a treat dispenser, wherein the treat dispenser is adapted to dispense a treat for a pet when the pet relieves itself on the pad.

It is important to house train a pet so that the pet does not urinate or defecate throughout the house. If the pet relieves itself in the house it can ruin furniture, carpets and clothing. Expensive cleaning products or steam cleaning services may be required to fully clean a soiled carpet. Further, cleaning products must be used which may be time consuming to apply in order to clean a surface thoroughly. Additionally, replacing damaged furniture and the like can be expensive and inconvenient.

Thus, it is important to teach a pet to relieve itself in designated areas, such as on a specific location within the home or outside of the home. Pets can be taught to perform a specific behavior if they are rewarded after performing the behavior. Rewarding the pet helps to establish a positive association with the performance of the behavior. While various pet training devices are available, such devices do not automatically reward a pet for its behavior and the user must actively reward the pet or provide positive reinforcement. However, the pet owner may not always be around when the pet urinates or defecates and, therefore, cannot always provide the reward that the pet requires to learn. If the pet owner only occasionally rewards or acknowledges the pet, the pet may have more difficulty learning to perform the desired behavior. Thus, a house training device for a pet that automatically rewards the pet for urinating or defecating in a specific location is desired.

Devices have been disclosed in the prior art that relate to house training devices. These include devices that have been patented and published in patent application publications. These devices generally relate to pet training devices, such as U.S. Published Patent Application Number 2008/0251026, U.S. Pat. No. 7,128,023, U.S. Published Patent Application Number 2008/0105208, U.S. Pat. No. 7,249,570, U.S. Pat. No. 5,355,837, and U.S. Published Patent Application Number 2014/0053783.

These prior art devices have several known drawbacks. The devices in the prior art primarily relate to pet waste holding or collection devices. While these devices provide a location in which a pet can urinate or defecate; however, these devices do not teach the pet to relieve itself in a desired location and do not encourage the pet to do so. Further, these devices fail to reward the pet for urinating or defecating in the desired location and do not include means for dispensing an edible treat.

In light of the devices disclosed in the prior art, it is submitted that the present invention substantially diverges in design elements from the prior art and consequently it is clear that there is a need in the art for an improvement to existing house training devices. In this regard the instant invention substantially fulfills these needs.

### SUMMARY OF THE INVENTION

In view of the foregoing disadvantages inherent in the known types of house training devices now present in the prior art, the present invention provides a new house training device wherein the same can be utilized for providing convenience for the user when training a pet to urinate or defecate in a specific location.

The present invention provides a house training device for a pet comprising a pad and a treat dispenser. The pad comprises a flat panel having an upper surface on which a disposable, absorbent sheet is adapted to be positioned. The pad includes fasteners on the corners thereof for removably securing the sheet onto the pad. A sensor is disposed within the pad, wherein the sensor detects if a pet has urinated or defecated thereon. If the sensor detects that the pet has urinated or defecated thereon, a control circuit causes the treat dispenser to automatically dispense a treat to reward the pet. The user can then dispose of and replace the disposable sheet.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the house training device.

FIG. 2 shows a side cross sectional view of the treat dispenser of the house training device.

FIG. 3 shows a schematic diagram of the control circuit of the house training device.

### DETAILED DESCRIPTION OF THE INVENTION

Reference is made herein to the attached drawings. Like reference numerals are used throughout the drawings to depict like or similar elements of the house training device. For the purposes of presenting a brief and clear description of the present invention, the preferred embodiment will be discussed as used for training a pet to urinate or defecate in a designated location. The figures are intended for representative purposes only and should not be considered to be limiting in any respect.

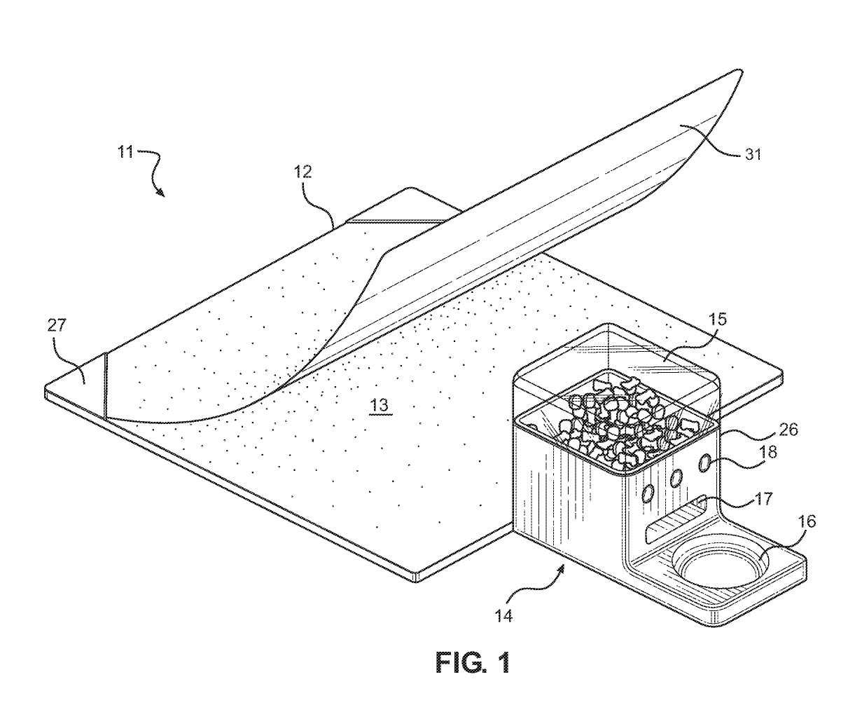

Referring now to FIG. 1, there is shown a perspective view of the house training device. The house training device 11 comprises a pad 12 and a treat dispenser 14 operably connected to one another via a control circuit. In operation, the user can encourage his or her pet to relieve itself on the pad 12. The pad 12 includes a sensor therein to determine if the pet has urinated or defecated on the pad 12. If the pet has urinated or defecated on the pad 12, the treat dispenser 14 is adapted to dispense an edible treat. In some embodiments, an audio unit is further provided that plays a pre-recorded message of encouragement for the pet when the pet has urinated or defecated on the pad 12. This helps to reinforce the behavior of the pet by rewarding the pet when the pet has urinated on the pad 12 as instructed by the pet owner.

The pad 12 comprises a flat panel with a flat upper surface 13 and is adapted to be placed on the floor of the pet owner's home. The pad 12 is shown as having a square shape, however, in alternate embodiments, the pad 12 can be any of various shapes, such as a rectangle or circle, among others. In some embodiments, the pad 12 is composed of a flexible material so that the pad 12 can contour to the floor or ground, and so that the pad 12 can be rolled for storage. A disposable sheet 31 is adapted to be positioned on the upper surface 13 of the pad 12, wherein the disposable sheet absorbs or collects the pet's waste. This helps to prevent the pad 12 itself from becoming soiled and unsanitary. Preferably, the disposable sheet 31 is composed of an absorbent material.

The pad 12 comprises one or more fasteners 27 thereon for removably securing the disposable sheet 31 on the upper surface 13 thereof. In the illustrated embodiment, the fasteners 27 are disposed on the corners of the pad 12. However, in alternate embodiments, the fasteners 27 may be disposed on the perimeter of the pad 12. Further, the fasteners 27 are shown as pockets in which a corner of the disposable sheet 31 can be positioned in order to help the disposable sheet 31 to remain in the desired position. In alternate embodiments, the fasteners 27 comprise clips for securing the edges of the disposable sheet 31. In some embodiments, the upper surface 13 of the pad 12 further comprises a non-slip or high friction material or coating to further secure the disposable sheet 31 in the proper position on the pad 12.

A treat dispenser 14 is operably connected to the pad 12. In the illustrated embodiment, the treat dispenser 14 is physically connected to an edge of the pad 12. In alternate embodiments, the treat dispenser 14 is wirelessly connected to the pad 12 so that the pad 12 and the treat dispenser 14 can be moved independently of one another. The treat dispenser 14 comprises a housing 26 adapted to store and dispense an edible treat for the pet. The upper end of the housing 26 includes a storage compartment that can be filled with treats for the pet. A lid 15 is removably secured over storage compartment so that the storage compartment cannot be accessed by the pet. A dispensing mechanism is provided wherein the dispensing mechanism includes a chute having a slot 17 on a side of the housing 26 through which a treat can be dispensed from the storage compartment, through the chute and into a serving tray 16 for the pet's consumption. In embodiments having an audio unit, the audio unit may be integrally formed with the treat dispenser 14.

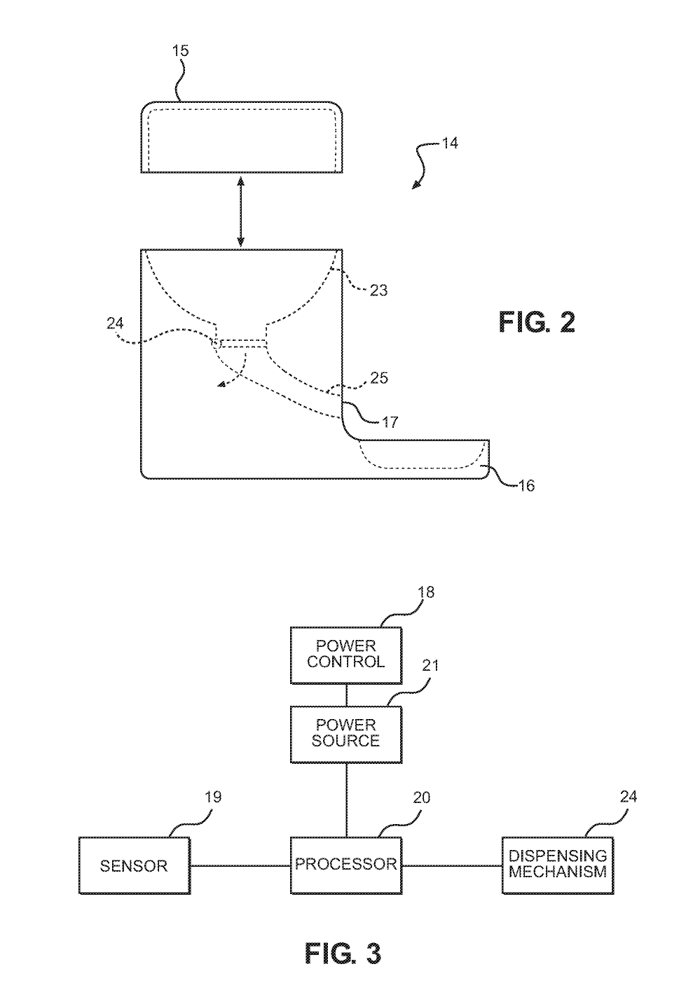

Referring now to FIG. 2, there is shown a side cross sectional view of the treat dispenser of the house training device. The treat dispenser 14 comprises a housing having an upper end and a lower end. The upper end includes a storage compartment 23 in which treats are adapted to be stored. The storage compartment 23 is removably covered by a lid 15. The lid 15 can be moved into an open configuration to fill the storage compartment 23 and can be pivoted into a closed configuration so that the pet cannot access the treats therein.

A dispensing mechanism 24 selectively dispenses treats from the storage compartment 23 into the serving tray 16. A chute 25 extends from the dispensing mechanism 24 to a slot 17 on the housing 12, wherein the treat can move between the storage compartment 23 through the chute 25 under the force of gravity. The dispensing mechanism 24 blocks the chute 25 so that no treats can pass therethrough. The dispensing mechanism 24 is preferably electronically actuated so that the dispensing mechanism 24 can selectively allow one or more treats to pass therethrough. Thus, the dispensing mechanism 24 functions similarly to a valve in selectively allowing the treats to pass therethrough.

Any of various types of dispensing mechanisms adapted to selectively dispense the stored treats can be utilized and it is not desired to limit the specific type of dispensing mechanism. In the illustrated embodiment, the dispensing mechanism 24 is shown as a movable lever that pivots between an open and closed configuration. In alternate embodiments, the dispensing mechanism 24 may include a screw wherein pet treats move along the threading of the screw, and the screw is rotated in order to release some of the pet treats stored on the screw.

Referring now to FIG. 3, there is shown a schematic diagram of the control circuit of the house training device. The house training device 11 comprises a control circuit for allowing the pad to communicate with the treat dispenser 14. The pad includes a sensor 19 therein that is operably connected to a processor 20, wherein the sensor 19 determines if the pet has urinated on the pad. The sensor 19 preferably comprises a weight sensor adapted to determine an incremental increase in the weight of the sheet on the pad. The weight sensor detects the weight of the pet on the pad, and once the pet leaves the pad, the weight sensor can determine if the disposable sheet's weight has increased due to the pet's waste being present thereon. Alternatively, the sensor 19 may include a moisture sensor adapted to detect any liquid present on the upper surface of the pad, or a pressure sensor adapted to detect the presence of waste thereon.

The processor 20 coordinates the action of the dispensing mechanism 24 so that the dispensing mechanism 24 dispenses a treat when the sensor 19 determines that the pet has urinated or defecated thereon. Further, in some embodiments, an audio unit 29 is also activated when the pet urinates or defecates on the pad. The audio unit 29 is adapted to play a pre-recorded message of encouragement for the pet. The audio unit 29 comprises a memory and a speaker for playing the pre-recorded message. A power source 21 such as one or more batteries is provided for powering the control circuit and its components. Further, a power control 18 is provided for allowing the user to turn the device on or off. It may be desirable to turn the device off when the pet is away from home or when the house training device is no longer needed so as to conserve battery power.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A house training device for a pet, comprising:
a pad having an upper surface on which a disposable sheet is adapted to be positioned;
a sensor integrated into the pad and adapted to determine if a pet has urinated on the pad;
a treat dispenser comprising a housing having a storage compartment in which one or more treats can be stored, a dispensing mechanism adapted to selectively dispense the one or more treats from the storage compartment through a slot on the housing;
a control circuit adapted to cause the dispensing mechanism to dispense a treat when the sensor detects that the pet has urinated on the pad.

2) The house training device of claim 1, wherein the upper surface of the pad comprises a high-friction material.

3) The house training device of claim 1, wherein the pad comprises one or more fasteners thereon, wherein the fasteners are adapted to removably secure the disposable sheet thereon.

4) The house training device of claim 1, wherein the sensor is a weight sensor.

5) The house training device of claim 1, wherein the sensor is a moisture sensor.

6) The house training device of claim 1, wherein the control circuit comprises a processor adapted to actuate the dispensing mechanism when the sensor detects that a pet has urinated on the pad.

7) The house training device of claim 1, wherein the treat dispenser further includes a tray adapted to catch a treat that has been dispensed through the slot on the housing.
